(19) United States
(12) Patent Application Publication
(10) Pub. No.: US 2005/0016804 A1
(43) Pub. Date: Jan. 27, 2005

(54) Hydrodynamic braking system provide with a retarder

(76) Inventors: Klause Vogelsang, Crailsheim (DE); Martin Deeg, Wort (DE); Walter Eberlein, Satteldorf (DE)

Correspondence Address: TAYLOR & AUST, P.C., 142 SOUTH MAIN STREET, P. O. BOX 560, AVILLA, IN, 46710, US

(21) Appl. No.: 10/492,989

(22) PCT Filed: Oct. 1, 2002
(86) PCT No.: PCT/EP02/10975

(30) Foreign Application Priority Data
Oct. 17, 2001 (DE) 10150681.3

(51) Int. Cl. F16D 57/02

(52) U.S. Cl. 188/296

(57) ABSTRACT

A hydrodynamic braking system with a retarder including a rotor arranged in a rotor housing and a stator arranged in a stator housing, whereby the rotor and the stator together form a working space. The rotor is axially movable relative to the stator, from a first position (braking operating position) to a second position (non-braking operating position), and vice versa. The axial distance between the rotor and the stator in the non-braking operating position is a multiple of the distance separating them in the braking operating position. According to one aspect of the present invention the rotor housing includes an outlet that is located at a distance from the axis of rotation of the rotor and is open toward the rotor in the non-braking operating position such that the operating medium collected by the rotor is conveyed outside the working space through the outlet.

### BACKGROUND OF THE INVENTION

1. Field of the Invention

The present invention pertains to a hydrodynamic braking system with a retarder, and, more particularly, to a hydrodynamic braking system with a secondary retarder.

2. Description of the Related Art

WO 00/40872 describes a retarder that, for the purpose of targeted emptying of the retarder to a predetermined level, is equipped with an outlet located on the back wall of the stator housing that discharges into an outlet chamber. A pressure impulse cylinder is connected to the outlet chamber whose piston accelerates excess operating medium and moves it against internal resistance until an optimum power loss operation is achieved.

A disadvantage of this design is that additional energy is required in order to effect the return transportation of excess operating medium from the retarder. In addition, the construction is complicated and its operation associated with additional mechanical losses.

What is needed in the art is a hydrodynamic braking system with a retarder whereby the return transportation of excess operating medium from the retarder is to be more effective when compared with the current state of the art. Specifically, what is needed is a hydrodynamic braking system with a retarder whereby a particularly effective evacuation of the retarder in the non-braking position to a predetermined level can be achieved so that the evacuation should occur automatically, that is independently.

### SUMMARY OF THE INVENTION

The present invention provides a retarder with a movable rotor meaning that, in a non-braking operational condition it assumes a so-called “second position”, whereby moving the rotor into this “second, or non-braking position” the power loss, in particular the air power loss of the retarder is low.

The invention comprises, in one form thereof, a hydrodynamic braking system with a retarder including a rotor arranged in a rotor housing and a stator arranged in a stator housing, whereby the rotor and the stator together form a working space. The rotor is axially movable relative to the stator, from a first position (braking operating position) to a second position (non-braking operating position), and vice versa. The axial distance between the rotor and the stator in the non-braking operating position is a multiple of the distance separating them in the braking operating position. According to the present invention the rotor housing includes an outlet that is located at a distance from the axis of rotation of the rotor and is open toward the rotor in the non-braking operating position such that the operating medium collected by the rotor is conveyed outside the working space through the outlet.

Thereby the centrifugal force being exerted upon the operating medium in the rotating rotor is utilized in order to transport the operating medium through the outlet. The outlet is therefore provided at a location in the rotor housing, especially so that it is arranged radially internally opposite to the direction of the centrifugal force. The desired residual operating medium volume that is to remain in the retarder work space during non-braking operation can be adjusted through the radial position of the outlet.

In the so-called “first position” during the braking operation the rotor is located relatively closely to the stator. The gap between the rotor and the stator blade tips is preferably only a few millimeters. In the non-braking position the gap width is many times greater than the gap width of the braking position.

The axial movement of the rotor relative to the stator from a close position in the braking position to a more distant position in the non-braking operating position allows for a considerable reduction of retarder losses in the non-brake position compared to non-movable rotors.

During non-braking operation the retarder is largely emptied in order to prevent ventilation losses due to air and residual operating medium remaining in the work space. On the other hand, a certain residual volume of operating medium should remain for the purpose of achieving an optimum power loss value that is, a minimal ventilation loss, and especially for achieving heat removal.

Advantageously, the hydrodynamic braking system includes an external operating medium loop, especially for cooling of the operating medium that is heated during braking operation. The operating medium loop includes an equalizing reservoir with an operating medium discharge below the liquid level of the operating medium in the equalizing reservoir in order to compensate for leakages or volume differentials in the loop. The operating medium discharge in the equalizing reservoir is connected to at least one supply connection of the retarder via at least one supply line so that the operating medium can be fed into the working space from the equalizing reservoir. In one advantageous embodiment of the invention the outlet of the rotor housing is connected at least indirectly with the equalizing reservoir through a discharge line. This discharge line can discharge directly into the equalizing reservoir whereby the outlet is located below the liquid level in the equalizing reservoir. In another variation it can also discharge into a line section below the equalizing reservoir, between the equalizing reservoir and the supply line to the retarder.

In the event of an indirect connection of the outlet of the rotor housing with the equalizing reservoir an additional atmospherically linked reservoir can advantageously be provided in the external loop. This atmospherically linked reservoir is positioned at a geodetic height above the liquid level in the equalizing reservoir.

The atmospherically linked reservoir is connected via a line with the equalizing reservoir, and the discharge line that is connected to the outlet of the rotor housing discharges into the atmospherically linked reservoir. This has the advantage that the operating medium that is brought by way of the rotor in the non-braking operating position through the outlet in the rotor housing into the atmospherically linked reservoir, flows back into the equalizing reservoir due to gravitational force. This allows an especially low flow resistance to be achieved against which the operating medium is transported by way of the rotor through the outlet in the rotor housing. Since the discharge line flows into an atmospherically linked reservoir it is advantageous to provide a valve in the discharge line behind the outlet in the rotor housing, so that this line can be shut off securely during braking operation. It is especially advantageous if this valve is located directly on, or behind the outlet in the rotor housing. For example, shut-off valves or check valves are suitable.

If the discharge line discharges directly into the equalizing reservoir below the liquid level, or into a line below the equalizing reservoir, a throttle may be installed in the discharge line instead of the described valve. This throttle is preferably dimensioned so that the braking operation is not be negatively influenced however, at the same time achieving the desired discharge via the outlet in the non-braking operation.

In order to achieve sufficient cooling of the retarder, especially in non-braking operation, a continuous minimum mass flow of operating medium can advantageously be supplied through the retarder. This mass flow of operating medium that is referred to as cooling mass flow enters the retarder working through the supply line via a supply connection and exits it through the outlet in the rotor housing. It is advantageous to incorporate a pressure reducing element into the supply line whereby the reducing element has a continuously opened minimum flow cross section. On the one hand the pressure reducing element can be in the form of an adjustment device with a minimum flow cross section. On the other hand it may be in the form of an adjustment or shut-off element, that can especially be shut-off completely, whereby then parallel to this adjustment or shut-off element a throttle having a minimum flow cross section, especially a fixed cross section, is installed.

Likewise, a throttle element having a continuously opened flow cross section may be installed in the discharge line, whereby a particularly low flow resistance is achieved if a single pressure reducing element is provided. Particularly if the entire external operating medium loop is free of external energy supply, that is if no driven pumps or hydraulic pistons are provided, emptying of the retarder to a desired residual operating medium volume, or cooling in non-braking operation can be done especially effectively.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic view of an embodiment of a control diagram of a hydrodynamic braking system in accordance with the present invention, in non-braking operational condition, with a supply of the operating medium that is discharged from the retarder into an atmospherically linked reservoir;

FIG. 2 is a schematic view of an embodiment of a control diagram of a hydrodynamic braking system with a retarder in accordance with the present invention, whereby the operating medium that is discharged from the retarder is fed directly into an equalizing reservoir;

FIG. 3 is a schematic view of an embodiment of a control diagram of a hydrodynamic braking system with a retarder in accordance with the present invention, whereby the operating medium that is discharged from the retarder is fed directly into an equalizing reservoir having a minimum opening cross section in the discharge line;

FIG. 4 is a schematic view of an embodiment of a control diagram of a hydrodynamic braking system with a retarder in accordance with the present invention, whereby a continuous cooling flow occurs through the retarder and the discharged operating medium is fed into an atmospherically linked reservoir;

FIG. 5 is a schematic view of an embodiment of a control diagram of a hydrodynamic braking system with a retarder in accordance with the present invention, whereby a continuous cooling flow occurs and the discharged operating medium is fed into an equalizing reservoir;

FIG. 6 is a schematic view of an embodiment of a control diagram of a hydrodynamic braking system with a retarder in accordance with the present invention, whereby a continuous cooling flow occurs and a throttle is installed in the discharge line; and

FIG. 7 is a partially cross-sectional and partially schematic view of an embodiment of a retarder with an external loop in accordance with the present invention.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

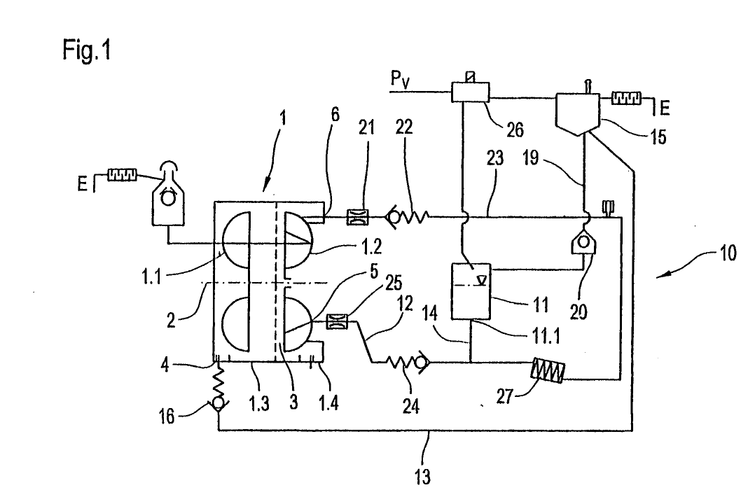

Referring now to the drawings, and more particularly to FIG. 1 there is shown a schematic illustration of retarder 1, including rotor 1.1 and stator 1.2. FIG. 1 further illustrates rotor housing 1.3 and stator housing 1.4. The non-braking operational condition is illustrated, that is, rotor 1.1 has been moved from stator 1.2 in axial direction, the direction of the axis of rotation 2 of the rotor, into a position of a greater distance, in order to avoid ventilation losses.

Outlet 4 is located in rotor housing 1.3 at a defined distance from the axis of rotation of the rotor. In this example the direction of the outlet is aligned radially, that is vertical to the rotor's axis of rotation. As indicated, projections, or a pipe section protrude radially in direction of rotor 1.1 beyond the inner surface of rotor housing 1.3. The height of this protrusion determines the residual operating medium that remains in the retarder housing. It is also possible to arrange the outlet in axial direction that is parallel to the rotor's axis of rotation 2, at a defined position, at a distance from the axis of rotation of rotor 2, whereby this defined radial position determines the volume of the residual operating medium remaining in the retarder housing.

Check-valve 16 is located near outlet 4 in rotor housing 1.3. Due to the motion of rotation of rotor 1.1, the excess operating medium is captured by rotor 1.1 and transported through outlet 4 via opened check-valve 16 and discharge line 13 into an atmospherically linked reservoir 15.

As illustrated, outlet 4 serves to empty retarder 1 completely or to the level of a defined residual operating medium volume. The cross section of outlet 4 and discharge line 13 is therefore relatively small when compared with the cross sections of the lines or flow elements in external loop 10 that have through-flow during braking operation. During braking operation the operating medium is fed into working space 3 of retarder 1 through supply line 12 and supply connection 5. In addition the operating medium is discharged from retarder I via outlet 6, following throttle 21 and check-valve 22 into line 23 to heat exchanger 27. From heat exchanger 27, where the heat volume that was supplied to the operating medium in retarder 1, is again evacuated, the operating medium flows back into retarder 1 through supply line 12 that is equipped with check-valve 24 and throttle 25.

An equalizing reservoir is provided in external loop 10. The equalizing reservoir includes an operating medium outlet 11.1 below the liquid level of the operating medium in equalizing reservoir 11. Line 14 is connected to operating medium outlet 11.1, that is positioned essentially vertically, or almost vertically, which connects operating medium outlet 11.1 with supply line 12. With the assistance of the operating medium in equalizing reservoir 11 leakages, for example, and volume differences that occur especially during the transition from the non-braking operational position to the braking operational position and vice versa in the retarder, or the external operating medium loop, can be equalized.

The atmospherically linked reservoir 15 into which the operating medium that is captured by rotor 1.1 in the non-braking operating position and transported through outlet 4 from retarder 1 is fed, is positioned at a geodetic height above equalizing reservoir 11. The atmospherically linked reservoir 15 is connected with equalizing reservoir 11 through line 19 with valve 20 which is designed as a gravity dependent check-valve so that the operating medium can flow from the atmospherically linked reservoir 15 back into equalizing reservoir 11, conditional upon gravity. At a time when the pressure in equalizing reservoir 11 exceeds a predetermined pressure value valve 20 closes.

Since discharge line 13 in this example feeds into the atmospherically linked reservoir 15, line 13 is shut off by check-valve 16 during braking operation. As illustrated in the control diagram, check-valve 16 is designed so that it closes due to the braking operating pressure in retarder 1 and is opened by a spring element against the lesser pressure in retarder 1 during non-braking operation, so that the operating medium can flow into reservoir 15.

The pressure in equalizing reservoir 11 through which the braking torque of retarder 1 in the braking operating position is controlled, is adjusted by way of the 3/2 directional control valve 26 that is designed as a continuously changeable proportional valve. In the illustrated example the control medium with which the 3/2 directional control valve 26 is supplied (with the pressure Pᵥ,) is separated from the operational medium. This is however, not imperative. A control valve that is supplied with operating medium can also be utilized to control the pressure in equalizing reservoir 11.

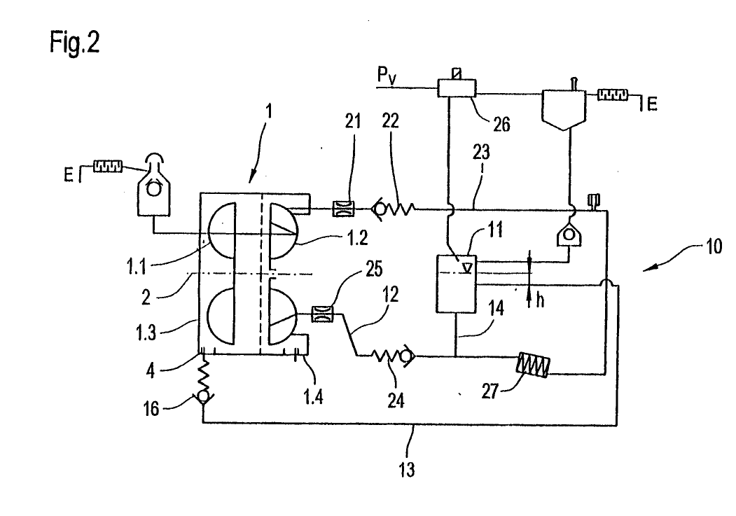

FIG. 2 illustrates another embodiment of a hydrodynamic braking system with retarder 1.

Identical references are assigned to identical elements. In this example, discharge line 13 that is connected to outlet 4 of rotor housing 1.3 feeds into the equalizing reservoir 11 below the operating medium level. The distance between the operating medium level and the opening of discharge line 13 is designated h. Essentially the same function mode as described in the first example (FIG. 1) results. It is however, also be feasible to let discharge line 13 flow into line 14 below equalizing reservoir 11.

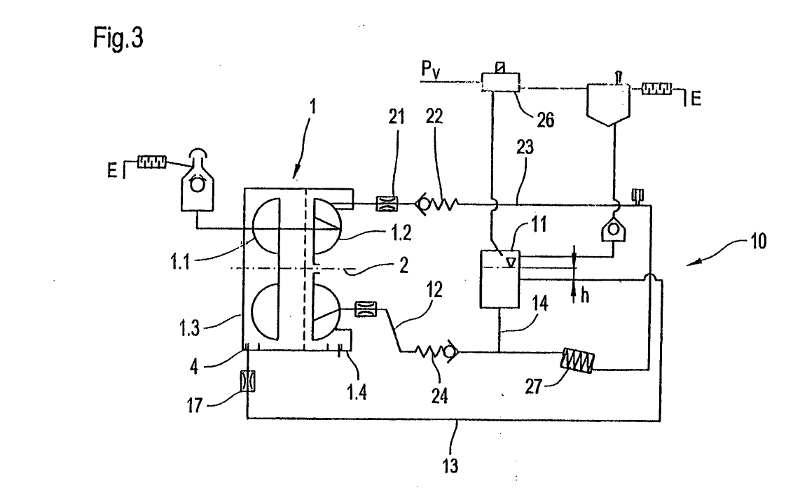

FIG. 3 illustrates an additional design example. Here too, discharge line 13 discharges below the operating medium level in equalizing reservoir 11. In this example throttle 17 instead of check valve 16 is incorporated into discharge line 13 after outlet 4 of rotor housing 1.3.

Throttle 17 provides a continuously open cross section. The cross section is selected so that no adverse effects occur in the braking operation and that at the same time in the non-braking operation, the desired operating medium volume which is captured by rotor 1.1 is discharged through outlet 4.

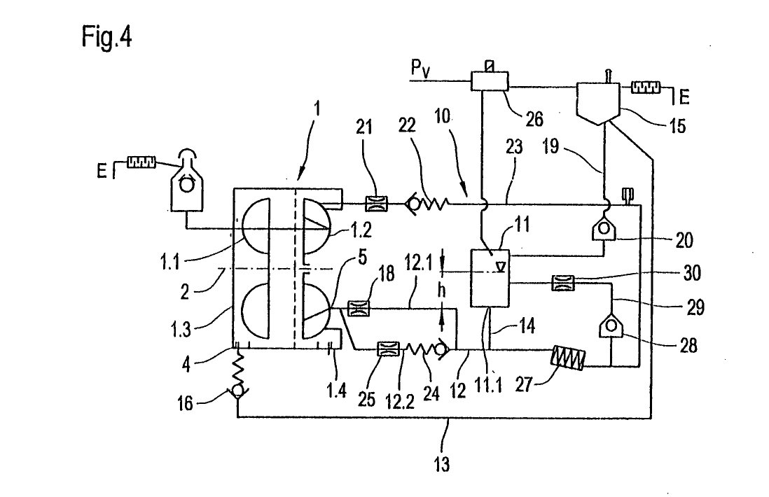

FIG. 4 is a control diagram of an additional design example. In this design example discharge line 13 discharges, as in FIG. 1, into an atmospherically linked reservoir 15 that is located at a geodetic level above equalizing reservoir 11 and from which the operating medium discharges through line 19 and valve 20 due to gravity into equalizing reservoir 11. A constant, but throttled line connection exists between equalizing reservoir 11 and supply connection 5 of retarder 1. Line 14 is connected to outlet 11. 1 of equalizing reservoir 11, below the operating medium level. The line progresses essentially vertically or almost vertically and connects equalizing reservoir 11 through supply line 12.

An additional line 29 is connected to equalizing reservoir 11 that connects the equalizing reservoir with the line segment prior to heat exchanger 27. Throttle element 30 and check-valve 28 that opens through the force of gravity are installed in line 29. In the braking position check-valve 28 is closed due to the dynamic pressure. The flow connection through line 14 on the other hand, is essentially only effective during braking.

In the further flow progression, supply line 12 splits into two parallel line branches 12.1 and 12.2. Line branches 12.1 and 12.2 are brought together again prior to supply connection 5. It is however, also feasible to have these line branches flow separately into different supply connections in retarder 1. Supply branch 12.2 based on the location of check-valve 24 in-line with throttle 25 is consistent with supply line 12 of the previously cited examples. In this design example, however, line branch 12.1 with throttle 18 that has a continuously open minimum cross section, or a fixed cross section is installed parallel to line branch 12.2. This opening cross section is preferably very small relative to, for example, throttle 25. This line branch 12.1 with throttle 18 ensures the continuous line connection from equalizing reservoir 11 to supply connection 5, and thereby into retarder operating chamber 3. Instead of, or in addition to, parallel line branch 12.1 it is also feasible to equip check-valve 24 with a continuously open minimum flow cross section, or to replace it with another suitable valve.

The dimension of throttle 18 in line branch 12.1 is selected so that an uninhibited braking operation is ensured. With the line connection from outlet 4 in rotor housing 1.3 through check-valve 16, discharge line 13 to the atmospherically linked reservoir 15 a low pressure return flow of the discharged operating medium is possible. This operating medium flows due to the force of gravity from the atmospherically linked reservoir 15 into equalizing reservoir 11. The gradient height h that results from the difference between the geodetic height between operating medium level in equalizing reservoir 11 and the geodetic height of supply connection 5, whereby the operating medium level in equalizing reservoir 11 is positioned above supply connection 5, ensures a continuous return flow of the operating medium into retarder 1, with rotating rotor 1.1. Since at the same time rotating rotor 1.1 transports an appropriate volume of operating medium through outlet 4, a reliable heat elimination is provided through this continuous operating medium flow rate. The desired coolant flow rate can be adjusted through adjustment of the gradient height h and selection of the suitable pressure reducing flow elements in the flow lines. In this manner, a reliable cooling operation without the introduction of external energy, for example in pumps or hydraulic pistons, is achieved especially effectively in the entire external operating medium loop 10.

In addition to the cooling function the throughput operating medium volume also fulfills the function in the non-braking operating position of lubricating the rotating retarder components, so that the flow rate is established especially also in dependence of a defined, necessary lubricant volume.

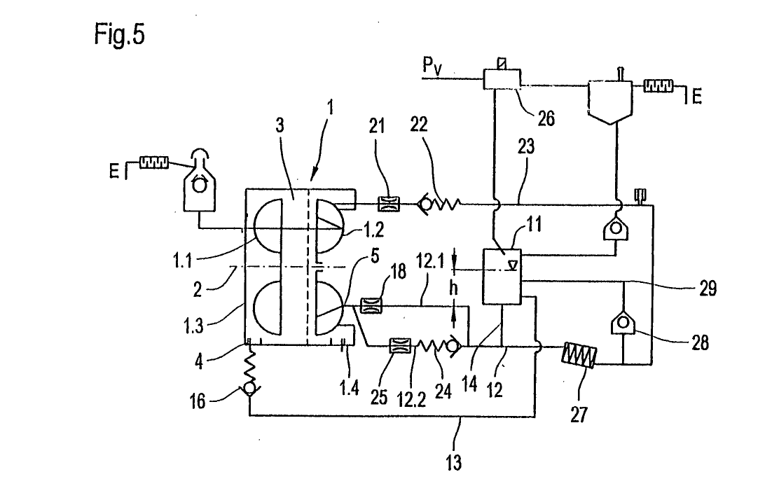

FIG. 5 illustrates a control diagram of another embodiment of the present invention. In contrast to FIG. 4, discharge line 13 is connected below the operating medium level in equalizing reservoir 11, the same as in FIGS. 2 and 3.

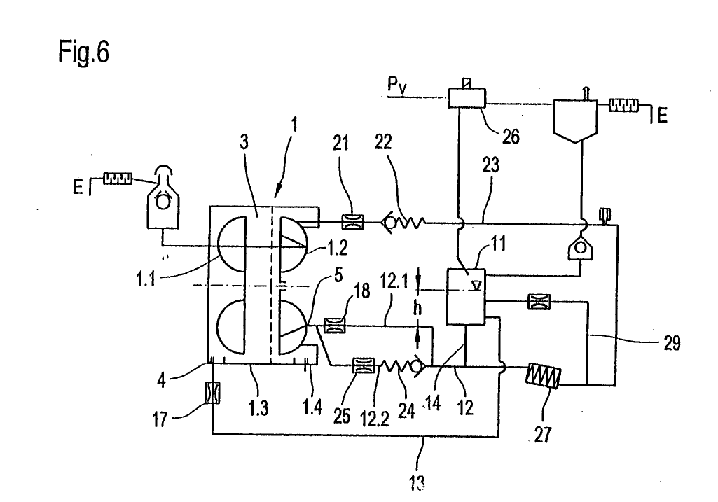

FIG. 6 illustrates another embodiment of the present invention. Here too, the discharge line flows into equalizing reservoir 1 1, below the operating medium level. In this example, check-valve 16 in discharge line 13 according to the example in FIG. 3 is replaced by throttle 17 with a continuously open flow cross section. Here too, as in the example illustrated in FIG. 5, a flow of operating medium results from equalizing reservoir 11 due to the geodetic height difference h between the operating medium level in equalizing reservoir 11 and supply connection 5 of retarder 1, into working space 3 of retarder 1. At the same time the portion of the operating medium that is captured by rotating rotor 1.1 is transported through outlet 4, throttle 17 and discharge line 13 into equalizing reservoir 11. This ensures a continuous cooling flow and especially also a lubricant flow whose volume flow can be regulated by way of the flow elements that are installed in the line connections, and the height difference h. The entire operating medium circuit is free of external energy supply, with the exception of the energy supplied to rotor 1.1.

In braking operation a flow cycle occurs from retarder 1 through line 23, heat exchanger 27, lines 12 and 12.2 into retarder 1. In non-braking operation a cooling/lubrication cycle occurs from retarder 1 through line 13, equalizing reservoir 11, line 29, heat exchanger 27, lines 12 and 12.1 into retarder 1. Line 14 serves essentially to fill retarder 1.

In the inventive hydrodynamic braking system all types of retarder can be utilized. Cited examples are primary retarder, secondary retarder, oil operated retarder, retarder operated with the operating medium of the vehicle cooling system (cooling water circulating pump retarder) retarder without bearings (over-mounted retarder) and retarder with (integrated) bearing assembly.

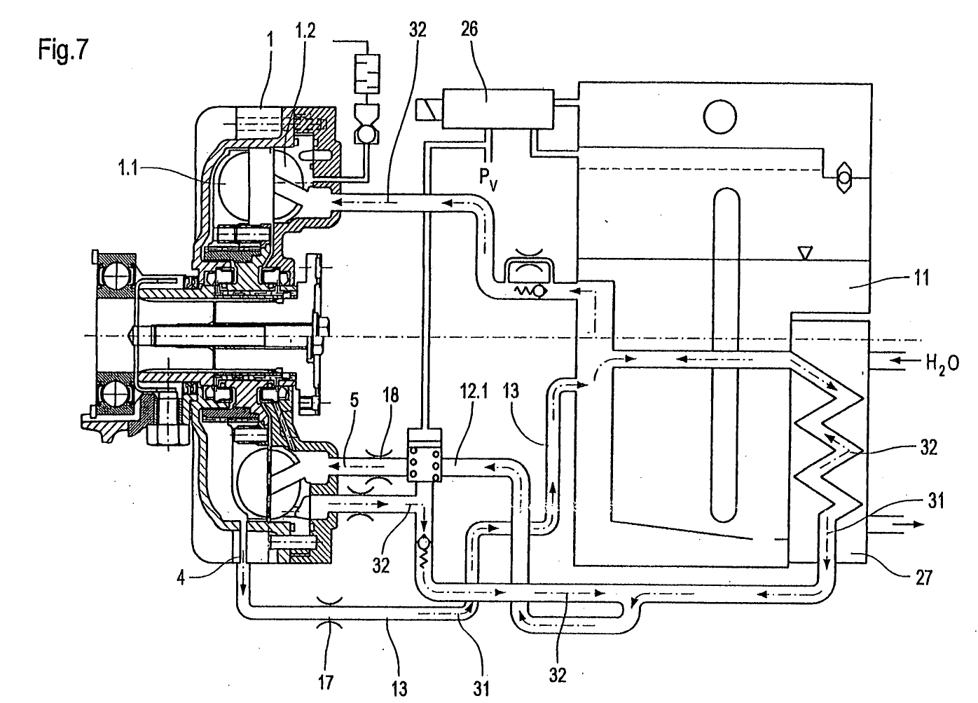

FIG. 7 illustrates an additional embodiment of the present invention that essentially is consistent with the schematic depiction in FIG. 6, however, in larger constructive detail. Same components are designated with the same references. Again, the flow in non-braking operation that serves the retention of a cooling and lubrication circuit is indicated by the unbroken arrow lines 31. This flow exits the retarder through outlet 4 and is returned to it again through supply connection 5.

In addition, the progression of the flow in braking operation is indicated by dot-dash line 32. As can be seen, this flow is partially in opposite direction to the progression of the flow in the non-braking operation. This permits a flow through heat exchanger 27 in opposite direction, and also the supply and discharge lines that are connected to the heat exchanger. In general all lines or channels through which medium flows exclusively in the non-braking operating position have a smaller cross section than the lines or channels through which operating medium flows exclusively or additionally in the braking operating position, since the volume flow of the operating medium during braking operation is clearly greater than the throughput lubricant/coolant volume in non-braking operation.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### Component Identification

1 Retarder
1.1 Rotor
1.2 Stator
1.3 Rotor housing
1.4 Stator housing
2 Axis of rotation of rotor
3 Working space
4 Outlet
5 Supply connection
6 Outlet
10 Operating medium loop
11 Equalizing reservoir
11.1 Operating medium discharge
12 Supply line
12.1, 12.2 Line branches
13 Discharge line
14 Line
15 Atmospherically linked reservoir
16 Check-valve
17 Throttle
18 Pressure reducing element
19 Line
20 Valve
21 Throttle
22 Check-valve
23 Line
24 Check valve
25 Throttle
26 3/2 directional valve
27 Heat exchanger
28 Check-valve
29 Line
30 Throttle element
31 Flow progression in non-braking operation
32 Flow progression in braking operation

1-10. (Canceled)

11. A hydrodynamic braking system equipped with a retarder, comprising:
a stator in a stator housing;
a rotor in a rotor housing, said rotor including an axis of rotation, said rotor and said stator together forming a working space, said rotor being axially movable relative to said stator from a first position being a braking operating position into a second position being a non-braking operating position, said rotor being axially movable relative to said stator from said non-braking operating position into said braking operating position, said rotor housing having an outlet being located at a distance from said axis of rotation, said outlet being open toward said rotor in said non-braking operating position such that an operating medium collected by said rotor is conveyed outside said working space through said outlet, said rotor and said stator defining a first axial distance therebetween in said braking operating position, said rotor and said stator defining a second axial distance therebetween in said non-braking operating position, said second axial distance being a multiple of said first axial distance.

12. The hydrodynamic braking system of claim 11, wherein said retarder is a secondary retarder.

13. The hydrodynamic braking system of claim 11, further including an external operating medium loop having an equalizing reservoir with an operating medium discharge below a liquid level of said operating medium in said equalizing reservoir, said operating medium discharge being connected to at least one supply connection of the retarder via at least one supply line for the purpose of supplying said operating medium to said working space, said outlet of said rotor housing being at least indirectly connected with said equalizing reservoir through a discharge line.

14. The hydrodynamic braking system of claim 13, further including an operating medium carrying line between said equalizing reservoir and said supply connection, said discharge line discharging directly into at least one of said equalizing reservoir below said liquid level and into said operating medium carrying line below said equalizing reservoir.

15. The hydrodynamic braking system of claim 13, wherein said external operating medium loop includes an atmospherically linked reservoir located at a geodetic height above said liquid level in said equalizing reservoir, said atmospherically linked reservoir is connected with said equalizing reservoir through a line, said discharge line flows into said atmospherically linked reservoir.

16. The hydrodynamic braking system of claim 13, further including a shut-off valve incorporated into said discharge line.

17. The hydrodynamic braking system of claim 16, wherein said shut-off valve is a check valve.

18. The hydrodynamic braking system of claim 13, further including a throttle incorporated into said discharge line.

19. The hydrodynamic braking system of claim 18, further including a pressure reducing element incorporated into said supply line, said pressure reducing element including a minimum flow cross section so that a continuous minimum mass flow of operating medium flows from said equalizing reservoir into said working space of the retarder.

20. The hydrodynamic braking system of claim 19, wherein said continuous minimum mass flow of operating medium is a cooling mass medium.

21. The hydrodynamic braking system of claim 19, wherein said pressure reducing element includes at least one of an adjustment device with a minimum flow cross section, a throttle that is located parallel to an adjustment element and a throttle that is located parallel to a shut-off element.

22. The hydrodynamic braking system of claim 13, further including a throttle element with a continuously opened flow cross section being incorporated into said discharge line.

23. The hydrodynamic braking system of claim 22, wherein said throttle element is a sole reducing element.

24. The hydrodynamic braking system of claim 13, wherein said external operating medium loop is absent of an external energy supply.
